(19) United States
(12) Patent Application Publication
(10) Pub. No.: US 2014/0040776 A1
(43) Pub. Date: Feb. 6, 2014

(54) SYSTEMS AND METHODS FOR BI-DIRECTIONAL DISPLAY OF CONTENT OF A SOCIAL NETWORKING SYSTEM

(71) Applicants: Jonathan P. Dann, Palo Alto, CA (US); Kimon Tsinteris, San Franciso, CA (US)

(72) Inventors: Jonathan P. Dann, Palo Alto, CA (US); Kimon Tsinteris, San Franciso, CA (US)

(21) Appl. No.: 13/565,625

(22) Filed: Aug. 2, 2012

(51) Int. Cl. G06F 3/0485

(52) U.S. Cl. CPC G06F 3/0485
USPC 715/753

(57) ABSTRACT

Techniques to allow optimized scrolling of information from a social networking system. In one embodiment, bi-directional display of references, such as content, is provided on a computer system, such as a mobile device. References are presented in a first orientation in a scrollable stream. In response to an interaction by a user, presentation of the scrollable stream is transformed from the first orientation to a second orientation. The first orientation may be substantially parallel with a length of an interface of the computer system. The first orientation and the second orientation may be orthogonal. Components of the references are omitted from presentation when the scrollable stream is presented in the first orientation. At least one of the omitted components of the references is included for presentation when the scrollable stream is presented in the second orientation.

### FIELD OF THE INVENTION

The present invention relates to the field of social networking. More particularly, the present invention provides a technique for facilitating horizontal and vertical browsing of content of a social networking system.

### BACKGROUND

Internet social networks have become a ubiquitous phenomenon. Social networks allow an Internet user to create an account and a user profile, usually for free, and interact with other users of the social network. A social network user can gain access to the profile of another user by requesting to add him or her as a friend. Usually, most information on a user's profile is accessible to the user's friends. Social network users typically assemble a group of friends or followers with whom they interact. A “friendship” typically gives both users access to each other's profiles and the content posted on them. Content postings and other user activities generate news stories that are visible to other users. A user may view news stories generated by the activities of his friends by accessing their profiles individually or by accessing his news feed, an interface that displays news stories from several users and summarizes the activities of the user's friends. Friends can usually comment on, share, or otherwise interact with each other's news stories.

Social networks are providing users with increasingly sophisticated functionality. Early social networks offered little more than a simple interface for users to communicate and post messages. Now, users may share numerous different types of content and interact with each other's content in a variety of ways. In addition, as technology has evolved, social networks have introduced tools for accessing social networking systems from a growing variety of technology platforms. Initially, because most users accessed the Internet exclusively from desktop computers, user interfaces of social networking systems were designed with desktop web browsers in mind. However, the exponential growth of mobile computing has facilitated Internet access from a variety of different devices and platforms. Because each technology platform has different technical capabilities and limitations, many social networks have interfaces that are customized for a particular platform. Thus, social networks may provide numerous applications and interfaces to optimize access from desktop computers, smartphones, tablets, and other devices. This evolution in the functionality offered by social networks and the modes by which they are accessed has necessitated more versatile user interfaces for viewing and interacting with user content. The smaller form factor of mobile devices in particular has necessitated more compact user interfaces that make more efficient use of space and rely on scrolling to a greater extent than desktop interfaces.

### SUMMARY

To allow optimized scrolling of information from a social networking system, embodiments of the invention include systems, methods, and computer readable media to allow bi-directional display of references, such as content, on a computing device. References are presented in a first orientation in a scrollable stream. In response to an interaction by a user, presentation of the scrollable stream is transformed from the first orientation to a second orientation.

In an embodiment, the first orientation and the second orientation are different. The first orientation is substantially parallel with a length of an interface of a computer system. The computer system may be a mobile device. The first orientation and the second orientation may be substantially orthogonal.

In an embodiment, components of the references are omitted from presentation when the scrollable stream is presented in the first orientation. At least one of the omitted components of the references is included for presentation when the scrollable stream is presented in the second orientation.

In an embodiment, the scrollable stream is scrolled in the first orientation and the second orientation. A reference is scrolled in the first orientation.

In an embodiment, the scrollable stream is a news feed. The references include news stories. The scrollable stream is presented in a webpage of a social networking system. The scrollable stream is associated with activities in a social networking system, the activities including at least one of an article posting, a link posting, a new friendship, a status update, and a photo upload.

Many other features and embodiments of the invention will be apparent from the accompanying drawings and from the following detailed description.

### BRIEF DESCRIPTION OF THE DRAWINGS

FIG. 1 depicts an example system for facilitating bi-directional display of content within a social networking system in accordance with an embodiment of the invention.

FIG. 2A depicts an example implementation of a story in accordance with an embodiment of the invention.

FIG. 2B depicts an example implementation of a news feed in accordance with an embodiment of the invention.

FIG. 3A depicts example components of a story in accordance with an embodiment of the invention.

FIG. 3B depicts an example news feed in an interface of a mobile device in accordance with an embodiment of the invention.

FIG. 4 depicts an example news feed oriented vertically in an interface of a mobile device in accordance with an embodiment of the invention.

FIG. 5 depicts an example news feed oriented horizontally in an interface of a mobile device in accordance with an embodiment of the invention.

FIG. 6 depicts an example user interaction with a component of a story within a vertical news feed of a mobile interface in accordance with an embodiment of the invention.

FIG. 7 depicts an example process for displaying bi-directional content in accordance with an embodiment of the invention.

FIG. 8 depicts an example of a computer system that may be used to implement one or more embodiments of the invention described herein.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Social Networking System Architecture

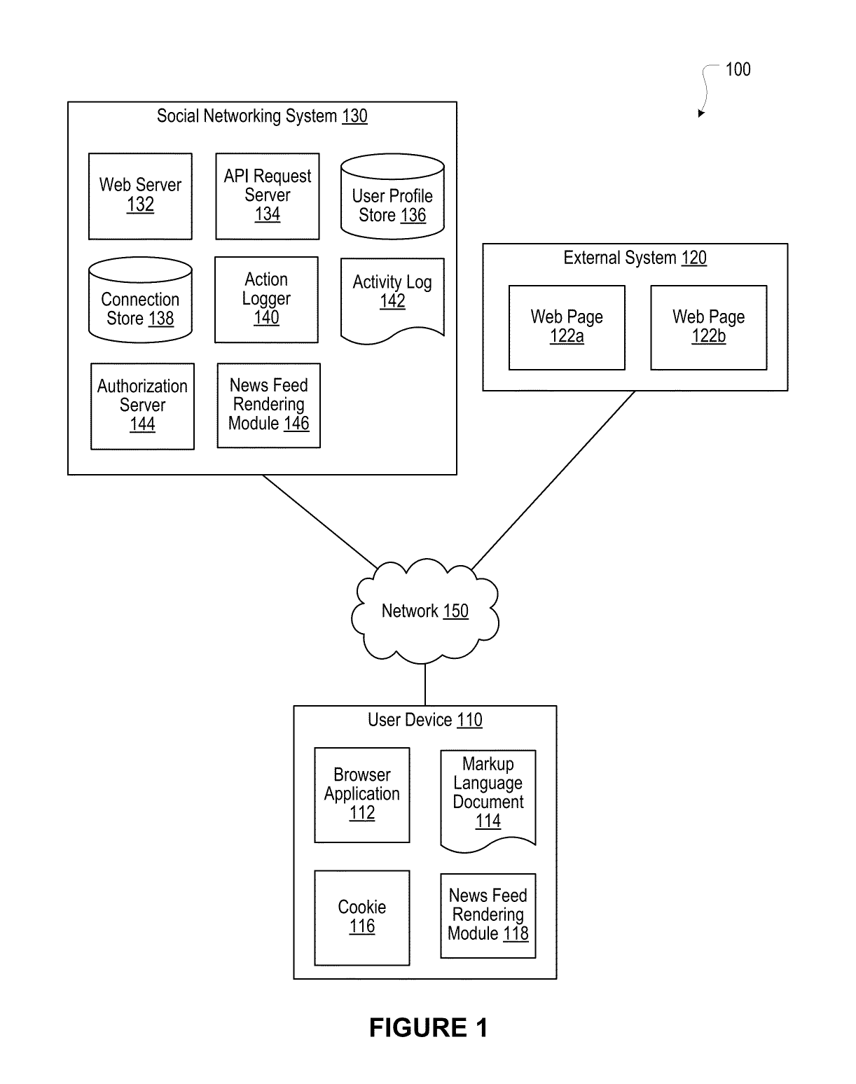

FIG. 1 is a network diagram of a system 100 for facilitating bi-directional display of content of a social networking system 130 in accordance with an embodiment of the invention. The system 100 includes one or more user devices 110, one or more external systems 120, the social networking system 130, and a network 140. For purposes of illustration, the embodiment of the system 100, shown by FIG. 1, includes a single external system 120 and a single user device 110. However, in other embodiments, the system 100 may include more user devices 110 and/or more external systems 120. In certain embodiments, the social networking system 130 is operated by a social network provider, whereas the external systems 120 are separate from the social networking system 130 in that they may be operated by different entities. In various embodiments, however, the social networking system 130 and the external systems 120 operate in conjunction to provide social networking services to users (or members) of the social networking system 130. In this sense, the social networking system 130 provides a platform or backbone, which other systems, such as external systems 120, may use to provide social networking services and functionalities to users across the Internet.

The user device 110 comprises one or more computing devices that can receive input from a user and transmit and receive data via the network 150. In one embodiment, the user device 110 is a conventional computer system executing, for example, a Microsoft Windows compatible operating system (OS), Apple OS X, and/or a Linux distribution. In another embodiment, the user device 110 can be a device having computer functionality, such as a smart-phone, a tablet, a personal digital assistant (PDA), a mobile telephone, etc. The user device 110 is configured to communicate via the network 150. The user device 110 can execute an application, for example, a browser application that allows a user of the user device 110 to interact with the social networking system 130. The user device 110 is configured to communicate with the external system 120 and the social networking system 130 via the network 150, which may comprise any combination of local area and/or wide area networks, using wired and/or wireless communication systems.

In one embodiment, the network 150 uses standard communications technologies and protocols. Thus, the network 150 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 150 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 150 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 110 may display content from the external system 120 and/or from the social networking system 130 by processing a markup language document 114 received from the external system 120 and from the social networking system 130 using a browser application 112. The markup language document 114 identifies content and one or more instructions describing formatting or presentation of the content. By executing the instructions included in the markup language document 114, the browser application 112 displays the identified content using the format or presentation described by the markup language document 114. For example, the markup language document 114 includes instructions for generating and displaying a webpage having multiple frames that include text and/or image data retrieved from the external system 120 and the social networking system 130. In various embodiments, the markup language document 114 comprises a data file including extensible markup language (XML) data, extensible hypertext markup language (XHTML) data, or other markup language data. Additionally, the markup language document 114 may include JavaScript Object Notation (JSON) data, JSON with padding (JSONP), and JavaScript data to facilitate data-interchange between the external system 120 and the user device 110. The browser application 112 on the user device 110 may use a JavaScript compiler to decode the markup language document 114.

The markup language document 114 may also include, or link to, applications or application frameworks such as FLASH™ or Unity™ applications, the SilverLight™ application framework, etc.

In one embodiment, the user device 110 also includes one or more cookies 116 including data indicating whether a user of the user device 110 is logged into the social networking system 130, which may enable customization of the data communicated from the social networking system 130 to the user device 110. In one embodiment, the user device 110 also includes a news feed rendering module 118.

The external system 120 includes one or more web servers that include one or more webpages 122a, 122b, which are communicated to the user device 110 using the network 150. The external system 120 is separate from the social networking system 130. For example, the external system 120 is associated with a first domain, while the social networking system 130 is associated with a separate social networking domain. Webpages 122a, 122b, included in the external system 120, comprise markup language documents 114 identifying content and including instructions specifying formatting or presentation of the identified content.

The social networking system 130 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure.

Users may join the social networking system 130 and then add connections to any number of other users of the social networking system 130 to whom they desire to be connected. As used herein, the term “friend” refers to any other user of the social networking system 130 to whom a user has formed a connection, association, or relationship via the social networking system 130. For example, in an embodiment, if users in the social networking system 130 are represented as nodes in the social graph, the term “friend” can refer to an edge formed between and directly connecting two user nodes.

Connections may be added explicitly by a user or may be automatically created by the social networking system 130 based on common characteristics of the users (e.g., users who are alumni of the same educational institution). For example, a first user specifically selects a particular other user to be a friend. Connections in the social networking system 130 are usually in both directions, but need not be, so the terms “user” and “friend” depend on the frame of reference. Connections between users of the social networking system 130 are usually bilateral (“two-way”), or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system 130 by Joe, but Joe does not wish to form a mutual connection, a unilateral connection may be established. The connection between users may be a direct connection; however, some embodiments of the social networking system 130 allow the connection to be indirect via one or more levels of connections or degrees of separation.

In addition to establishing and maintaining connections between users and allowing interactions between users, the social networking system 130 provides users with the ability to take actions on various types of items supported by the social networking system 130. These items may include groups or networks (i.e., social networks of people, entities, and concepts) to which users of the social networking system 130 may belong, events or calendar entries in which a user might be interested, computer-based applications that a user may use via the social networking system 130, transactions that allow users to buy or sell items via services provided by or through the social networking system 130, and interactions with advertisements that a user may perform on or off the social networking system 130. These are just a few examples of the items upon which a user may act on the social networking system 130, and many others are possible. A user may interact with anything that is capable of being represented in the social networking system 130 or in the external system 120, separate from the social networking system 130, or coupled to the social networking system 130 via the network 150.

The social networking system 130 is also capable of linking a variety of entities. For example, the social networking system 130 enables users to interact with each other as well as external systems 120 or other entities through an API, a web service, or other communication channels. The social networking system 130 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, webpages, groups, activities, messages, concepts, and any other things that can be represented by an object in the social networking system 130. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 130 modifies edges connecting the various nodes to reflect the relationships and interactions.

The social networking system 130 also includes user-generated content, which enhances a user's interactions with the social networking system 130. User-generated content may include anything a user can add, upload, send, or “post” to the social networking system 130. For example, a user communicates posts to the social networking system 130 from a user device 110. Posts may include data such as status updates or other textual data, location information, images such as photos, videos, links, music or other similar data and/or media. Content may also be added to the social networking system 130 by a third-party. Content “items” are represented as objects in the social networking system 130. In this way, users of the social networking system 130 are encouraged to communicate with each other by posting text and content items of various types of media through various communication channels. Such communication increases the interaction of users with each other and increases the frequency with which users interact with the social networking system 130.

The social networking system 130 includes a web server 132, an API request server 134, a user profile store 136, a connection store 138, an action logger 140, an activity log 142, an authorization server 144, and a news feed rendering module 146. In an embodiment of the invention, the social networking system 130 may include additional, fewer, or different components for various applications. Other components, such as network interfaces, security mechanisms, load balancers, failover servers, management and network operations consoles, and the like are not shown so as to not obscure the details of the system.

The user profile store 136 maintains information about user accounts, including biographic, demographic, and other types of descriptive information, such as work experience, educational history, hobbies or preferences, location, and the like that has been declared by users or inferred by the social networking system 130. This information is stored in the user profile store 136 such that each user is uniquely identified. The social networking system 130 also stores data describing one or more connections between different users in the connection store 138. The connection information may indicate users who have similar or common work experience, group memberships, hobbies, or educational history. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 130, such as non-person entities, buckets, cluster centers, images, interests, pages, external systems, concepts, and the like are also stored in the connection store 138.

The social networking system 130 maintains data about objects with which a user may interact. To maintain this data, the user profile store 136 and the connection store 138 store instances of the corresponding type of objects maintained by the social networking system 130. Each object type has information fields that are suitable for storing information appropriate to the type of object. For example, the user profile store 136 contains data structures with fields suitable for describing a user's account and information related to a user's account. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user profile store 136, assigns a unique identifier to the user account, and begins to populate the fields of the user account with information provided by the user.

The connection store 138 includes data structures suitable for describing a user's connections to other users, connections to external systems 120 or connections to other entities. The connection store 138 may also associate a connection type with a user's connections, which may be used in conjunction with the user's privacy setting to regulate access to information about the user. In an embodiment of the invention, the user profile store 136 and the connection store 138 may be implemented as a federated database.

Data stored in the connection store 138, the user profile store 136, and the activity log 142 enables the social networking system 130 to generate the social graph that uses nodes to identify various objects and edges connecting nodes to identify relationships between different objects. For example, if a first user establishes a connection with a second user in the social networking system 130, user accounts of the first user and the second user from the user profile store 136 may act as nodes in the social graph. The connection between the first user and the second user stored by the connection store 138 is an edge between the nodes associated with the first user and the second user. Continuing this example, the second user may then send the first user a message within the social networking system 130. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 130 (or, alternatively, in an image maintained by another system outside of the social networking system 130). The image may itself be represented as a node in the social networking system 130. This tagging action may create edges between the first user and the second user as well as create an edge between each of the users and the image, which is also a node in the social graph. In yet another example, if a user confirms attending an event, the user and the event are nodes obtained from the user profile store 136, where the attendance of the event is an edge between the nodes that may be retrieved from the activity log 142. By generating and maintaining the social graph, the social networking system 130 includes data describing many different types of objects and the interactions and connections among those objects, providing a rich source of socially relevant information.

The web server 132 links the social networking system 130 to one or more user devices 110 and/or one or more external systems 120 via the network 150. The web server 132 serves webpages, as well as other web-related content, such as Java, JavaScript, Flash, XML, and so forth. The web server 132 may include a mail server or other messaging functionality for receiving and routing messages between the social networking system 130 and one or more user devices 110. The messages can be instant messages, queued messages (e.g., email), text and SMS messages, or any other suitable messaging format.

The API request server 134 allows one or more external systems 120 and user devices 110 to call access information from the social networking system 130 by calling one or more API functions. The API request server 134 may also allow external systems 120 to send information to the social networking system 130 by calling APIs. The external system 120, in one embodiment, sends an API request to the social networking system 130 via the network 150, and the API request server 134 receives the API request. The API request server 134 processes the request by calling an API associated with the API request to generate an appropriate response, which the API request server 134 communicates to the external system 120 via the network 150. For example, responsive to an API request, the API request server 134 collects data associated with a user, such as the user's connections that have logged into the external system 120, and communicates the collected data to the external system 120. In another embodiment, the user device 110 communicates with the social networking system 130 via APIs in the same manner as external systems 120.

The action logger 140 is capable of receiving communications from the web server 132 about user actions on and/or off the social networking system 130. The action logger 140 populates the activity log 142 with information about user actions, enabling the social networking system 130 to discover various actions taken by its users within the social networking system 130 and outside of the social networking system 130. Any action that a particular user takes with respect to another node on the social networking system 130 may be associated with each user's account, through information maintained in the activity log 142 or in a similar database or other data repository. Examples of actions taken by a user within the social networking system 130 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 130, the action is recorded in the activity log 142. In one embodiment, the social networking system 130 maintains the activity log 142 as a database of entries. When an action is taken within the social networking system 130, an entry for the action is added to the activity log 142. The activity log 142 may be referred to as an action log.

Additionally, user actions may be associated with concepts and actions that occur within an entity outside of the social networking system 130, such as an external system 120 that is separate from the social networking system 130. For example, the action logger 140 may receive data describing a user's interaction with an external system 120 from the web server 132. In this example, the external system 120 reports a user's interaction according to structured actions and objects in the social graph.

Other examples of actions where a user interacts with an external system 120 include a user expressing an interest in an external system 120 or another entity, a user posting a comment to the social networking system 130 that discusses an external system 120 or a webpage 122a within the external system 120, a user posting to the social networking system 130 a Uniform Resource Locator (URL) or other identifier associated with an external system 120, a user attending an event associated with an external system 120, or any other action by a user that is related to an external system 120. Thus, the activity log 142 may include actions describing interactions between a user of the social networking system 130 and an external system 120 that is separate from the social networking system 130.

The authorization server 144 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 120, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 120. One embodiment allows the specification of the set of entities to comprise an enumeration of entities. For example, the user may provide a list of external systems 120 that are allowed to access certain information. Another embodiment allows the specification to comprise a set of entities along with exceptions that are not allowed to access the information. For example, a user may allow all external systems 120 to access the user's work information, but specify a list of external systems 120 that are not allowed to access the work information. Certain embodiments call the list of exceptions that are not allowed to access certain information a “block list”. External systems 120 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 144 contains logic to determine if certain information associated with a user can be accessed by a user's friends, external systems 120, and/or other applications and entities. The external system 120 may need authorization from the authorization server 144 to access the user's more private and sensitive information, such as the user's work phone number. Based on the user's privacy settings, the authorization server 144 determines if another user, the external system 120, an application, or another entity is allowed to access information associated with the user, including information about actions taken by the user.

The news feed rendering module 146 of the social networking system 130 interfaces with the news feed rendering module 118 of the user device 110 so that a news feed can be formatted for presentation on the user device 110. In an embodiment, the news feed is formatted by the news feed rendering module 118 to display scrollable streams of content items or any other type of references in different orientations (e.g., vertical orientation and horizontal orientation). A user input applied to the user device 110 may cause the news feed to be transformed from one orientation to another orientation (e.g., from a vertical orientation to a horizontal orientation). Bi-directional display of the news feed is described in further detail below.

### Bi-Directional Display of Content

As described above, for each user activity within the social networking system 130, the social networking system 130 may generate a visual representation of the activity in the form of a story. A story may appear on a user's profile, in other users' news feeds, or elsewhere. The activity may be an article posting, a status update, a “like”, a comment, a share, a photo upload, a new friendship, or any other interaction, activity, or event that may occur within or become known to the social networking system 130. The story may include links to a user's profile, a link to the content being posted, a link to the pictures being uploaded, or any other items that can be viewed or selected by another user who views the story. Any type of data pertaining to the activity may be included in the story.

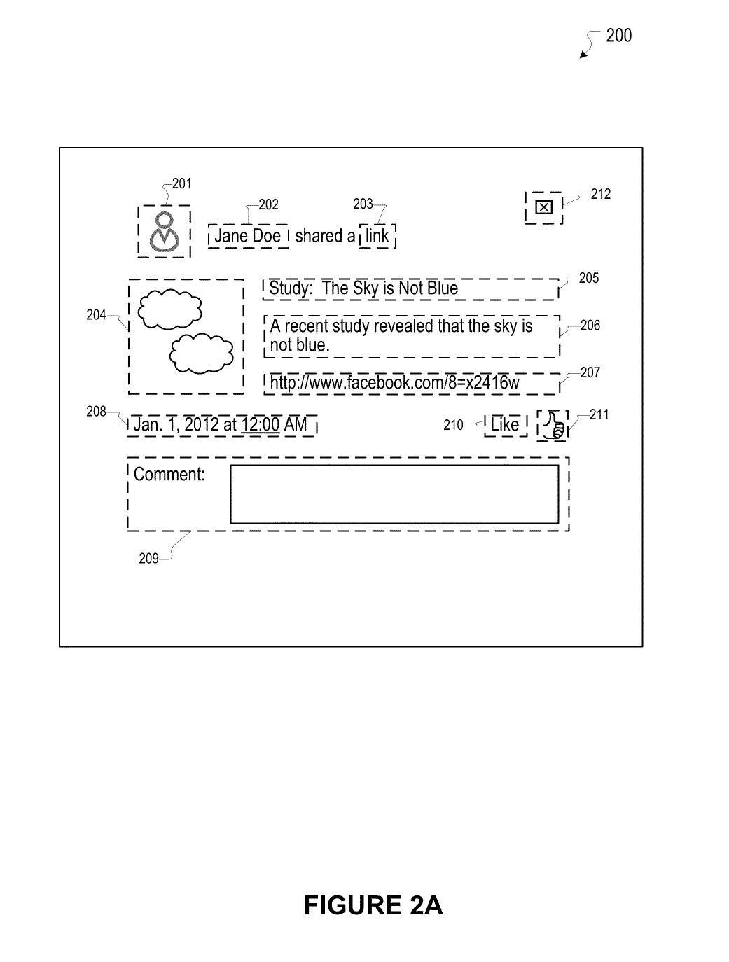

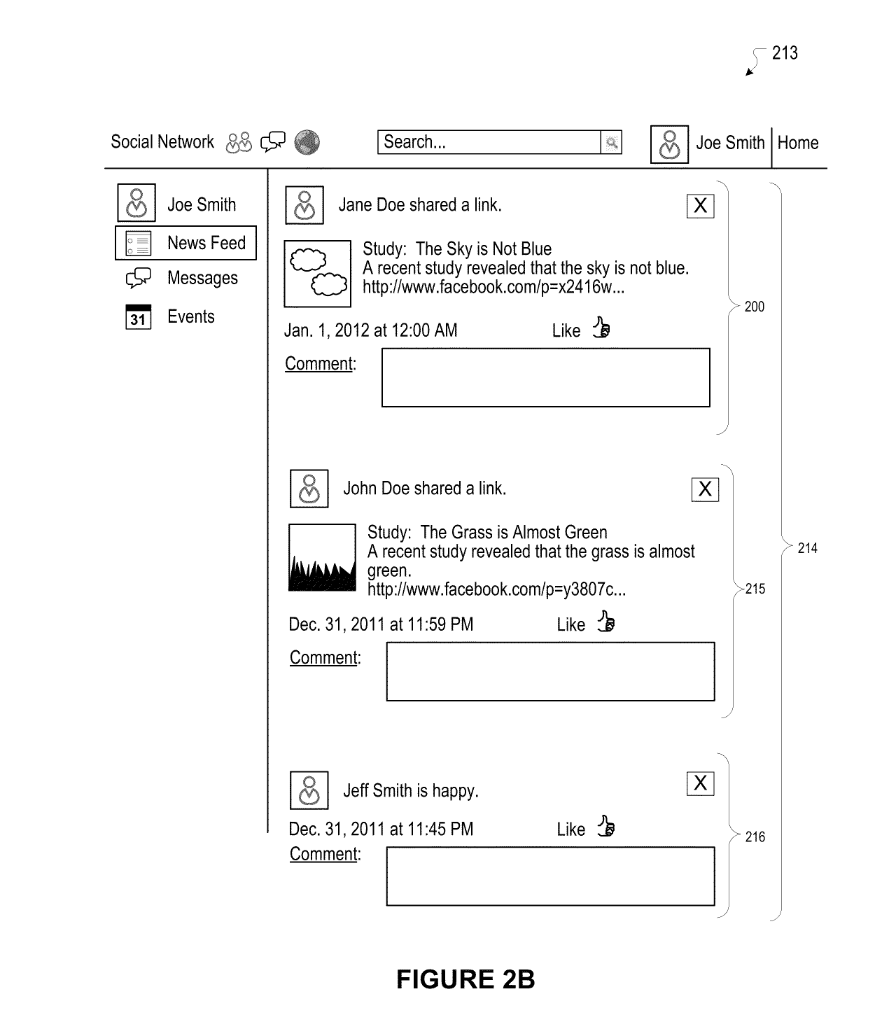

FIG. 2A illustrates an example implementation of a story 200 in accordance with an embodiment of the invention. In the illustrated example, the story 200 is presented as a discrete content item comprising a number of components. The story 200 indicates that user Jane Doe posted an article. The story 200 includes various content components 201-212 that may link to Jane Doe's profile, the article, and options to “like” or comment on the link. Component 201, which corresponds to Jane's profile picture, and component 202, which corresponds to Jane's name, may link to Jane's profile. Component 203, which corresponds to the word “link”; component 204, which corresponds to a thumbnail accompanying the article; component 205, which corresponds to the title of the article; component 206, which corresponds to a brief synopsis of the article; and component 207, which corresponds to the URL of the article, may link to the article. Component 208, which corresponds to the timestamp of the story, and component 209, which corresponds to a comment box, may link to commenting functionality. Component 210, which corresponds to the word “like”, and component 211, which corresponds to a thumbs up icon, may link to “like” functionality. Component 212, which corresponds to the “X”, may link to functionality for hiding or closing the story 200. Other components not shown in FIG. 2A may also be included in a story.

According to one embodiment, news stories may be viewed by a user within the profiles of the user's friends or within the user's news feed. A news feed is a collection of news stories summarizing the activities of some users of the social networking system 130. According to one embodiment, a user's news feed may include news stories from friends of the user or other entities about activities for which the user is to receive updates. Because a user profile or a news feed may present a synopsis of a user's or users' activities, news stories may have dimensions large or long enough to convey a summary of the activity, but small or short enough such that a user viewing the profile or news feed need not scroll excessively to read through them.

FIG. 2B illustrates an example implementation of a news feed in accordance with an embodiment of the invention. In FIG. 2B, a webpage 213 includes a news feed 214 of user Joe Smith. The news feed 214 includes the story 200 illustrated in FIG. 2A. The news feed 214 further includes news stories 215 and 216 indicating that user John Doe has posted an article and user Jeff Smith has posted a status update, respectively. User Joe Smith, who is friends with these users, may see the webpage 213 upon logging into his account on the social networking system 130.

The story 200 and the webpage 213 may be designed for display within a desktop web browser. Because desktop displays may provide an ample amount of space for the presentation of content and user interface elements, a user viewing the webpage 213 on a desktop PC would have little trouble reading and navigating the news feed 214. In addition, the user may easily access the functionality linked to by the components of the story 200 using a mouse or other input mechanism. However, many technology platforms may not provide the size or functionality of a desktop computer. For example, mobile devices may have smaller screens and more limited input capabilities than desktop computers. On a mobile device, data input and output may occur via a small, touch-sensitive screen. A webpage designed for display on a desktop web browser can typically be viewed on a mobile device, but may be displayed in compressed form to accommodate the smaller form factor of the mobile device. Users who access the webpage 213 on a mobile device may find it more difficult to read and navigate the news feed 214 on a smaller screen or select the smaller dimensioned components of the story 200 using just their fingers. Thus, on a mobile device, the story 200 and the webpage 213 may need to be formatted differently to accommodate the mobile device's size, capabilities, and features.

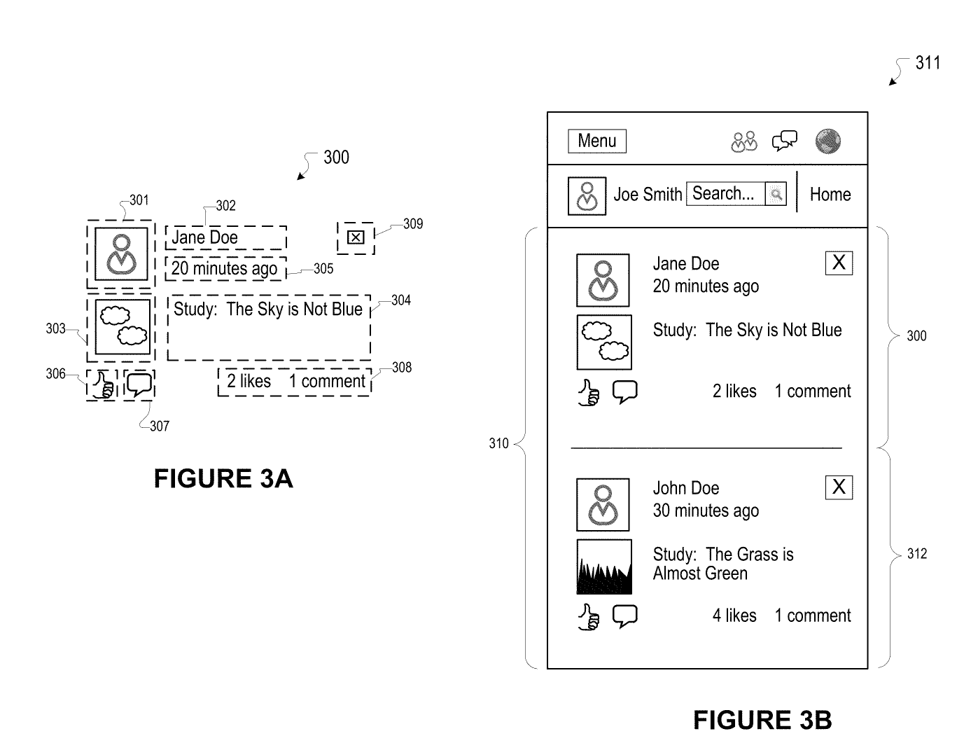

FIGS. 3A and 3B illustrate an example implementation of a story 300 and a news feed 310 within an interface 311 formatted specifically for a mobile device in accordance with an embodiment of the invention. According to one embodiment of the invention, the mobile interface 311 may be provided within an application specifically designed for a particular technology platform. According to another embodiment of the invention, the mobile interface 311 may be provided within a website optimized for mobile platforms in general, which is accessed using a browser application. Any application for displaying the mobile interface 311 may be used.

FIG. 3A illustrates the various components of the story 300, which is analogous to the story 200 of FIG. 2A, in accordance with an embodiment of the invention. Like the story 200, the story 300 indicates that user Jane Doe posted an article. However, the story 300 may contain fewer components than the story 200 in order to account for the smaller form factor of a mobile device. Component 301 corresponds to Jane Doe's profile picture. Component 302 corresponds to Jane Doe's name. Component 303 corresponds to a thumbnail accompanying the article. Component 304 corresponds to the title of the article. Component 305 corresponds to the timestamp of the story. Component 306 corresponds to a thumbs up icon. Component 307 corresponds to a comment icon. Component 308 corresponds to text indicating how many users have “liked” or commented on the story. Component 309 corresponds to the “X”. Notably, the story 300 lacks any components analogous to components 203, 206, 207, and 209 of the story 200. In another embodiment of the invention, the story 300 may include these components but lack other components.

FIG. 3B illustrates an example mobile interface 311 with the news feed 310 that includes the story 300 and a story 312. The story 312 indicates that user John Doe has posted an article and is analogous to the story 215 in FIG. 2B.

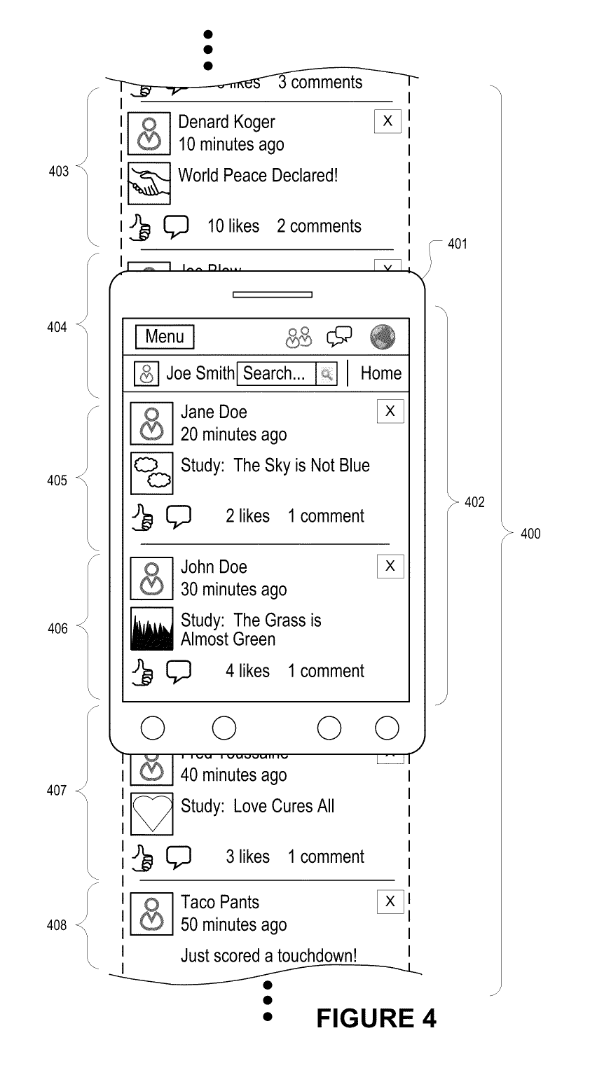

On mobile devices, due to the small screen size, the importance of optimizing the amount of scrolling that a user must perform to navigate a news feed may be even more pronounced. FIG. 4 depicts a news feed 400 of user Joe Smith oriented vertically within a mobile interface 402 on a mobile device 401. For purposes of explanation, the news feed 400 is shown to extend far above and below the screen area of the mobile device 401. News stories 405 and 406 are visible to user Joe Smith within the mobile interface 402. In order to see news stories 403 and 404, user Joe Smith may scroll up above the current view of the mobile interface 402. In order to see news stories 407 and 408, user Joe Smith may scroll down below the current view of the mobile interface 402. According to one embodiment of the invention, user Joe Smith may scroll through the news feed 400 by swiping or dragging his finger vertically across the screen of the mobile device 401. As used herein, the term “vertical” (or “vertically”), where appropriate in context, may refer to or describe presentation or scrolling of a reference, content item, news feed, or other stream in an orientation that is substantially along or parallel to a length or width of computer system (e.g., the mobile device 401), or an interface or display of the computer system (e.g., the mobile interface 402). The term “horizontal” (or “horizontally”) may refer to or describe such presentation or scrolling in an orientation that is substantially orthogonal to “vertical” (or “vertically”). A “stream” may refer to presentation of references, such as content items, in a series.

FIGS. 2B, 3B, and 4 illustrate that, in compressing the news stories to fit the mobile interface 311, certain useful components of each story may be sacrificed to facilitate usability and readability. However, it may be desirable to retain these components within the news feed in some form. For example, retaining a comment box in the story 300 within the news feed 310 may allow user Joe Smith to post a comment on the story 300 as he scrolls through the news feed without experiencing the inconvenience of having to separately visit user Jane Doe's profile or access story 300 some other way. Another advantage of this approach is that Joe Smith may move on to the next story in the news feed immediately upon posting his comment. Similarly, in assessing whether to access the article linked in the story 300, Joe Smith may wish to see, within the news feed 310, a synopsis similar to that of component 206 of the story 200.

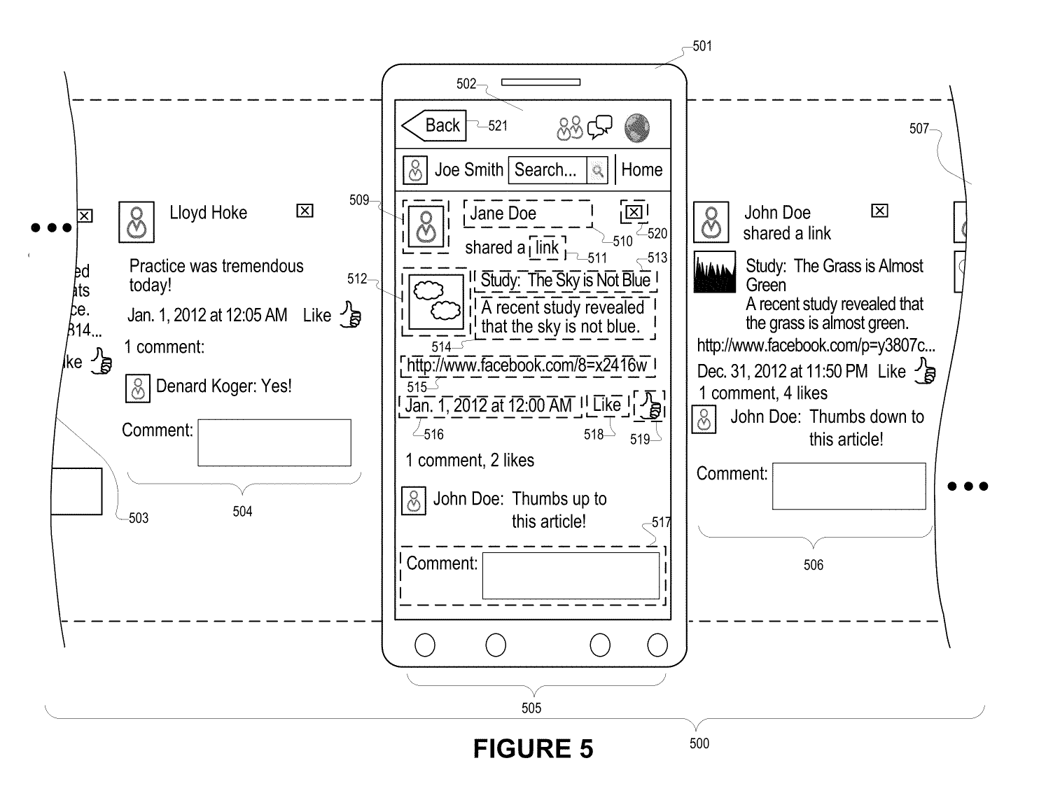

According to one embodiment of the invention, the news feed 400 may be changed from a vertically-oriented news feed to a horizontally-oriented news feed. This is illustrated by FIG. 5. FIG. 5 depicts a news feed 500 of user Joe Smith oriented horizontally within a mobile interface 502 on a mobile device 501. A story 505 is visible to user Joe Smith within the mobile interface 502. In order to see news stories 503 and 504, user Joe Smith may scroll to the left of the current view of the mobile interface 502. In order to see news stories 506 and 507, user Joe Smith may scroll to the right of the current view of mobile interface 502. The news stories 503-507 of the news feed 500, as shown for the purposes of illustration, are analogous to the news stories 403-407 of the news feed 400, with an important distinction: they may include a greater number of components, similar to the story 200 of FIG. 2A. Components 509-520 of the story 500 are each analogous to components 201-212 of the story 200, respectively, and may link to similar functionality. A “back” button 521, when selected, may trigger functionality that displays a vertical news feed similar to the news feed 400 of FIG. 4 within the mobile interface 502. Because the user now scrolls horizontally instead of vertically to navigate the news feed 500, the available screen space within the mobile interface 502 may be used for one story, leaving more space for the placement and arrangement of components within each story. The user may still scroll vertically to access components or portions of the story that are beyond the view of the mobile interface 502. According to one embodiment of the invention, user Joe Smith may scroll through the news feed 500 or a particular story by swiping or dragging his finger horizontally or vertically, respectively, across the screen of the mobile device 501.

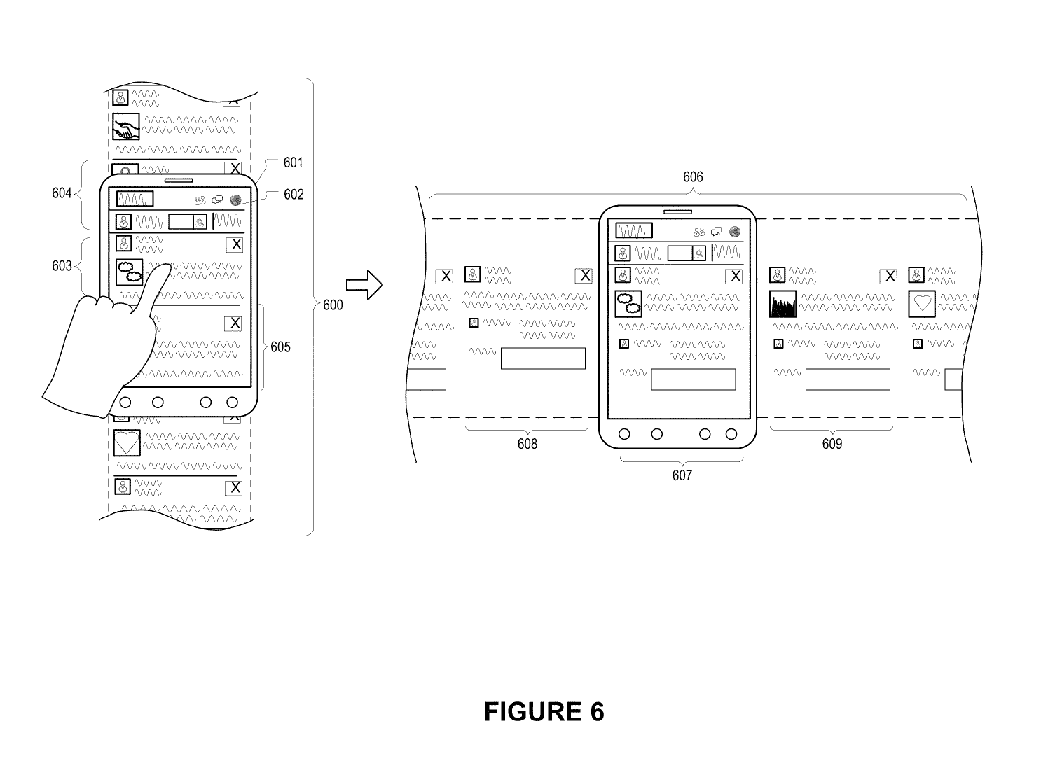

According to one embodiment of the invention, a user may view and scroll the news stories within his news feed both vertically as depicted in FIG. 4 and horizontally as depicted in FIG. 5. This bi-directional viewing and scrolling may be facilitated by linking one or more of the components of a story displayed in a vertical news feed, such as the story 300, to functionality that transforms or “flips” the vertical news feed into a horizontal news feed, in accordance with an embodiment of the invention. FIG. 6 depicts a user of a mobile device 601 selecting a component of a story 603 within a vertical news feed 600 of a mobile interface 602. The news stories in the news feed 600 may include components analogous to those of the news stories 403-408 in FIG. 4. According to an embodiment of the invention, the user may select any component within any story of the news feed 600 and thereby trigger functionality that transforms the news feed 600 from a vertical orientation to a horizontal orientation. In an embodiment, all components of the story may link to functionality that activates a horizontal news feed 606 when one of the components is selected by the user. According to another embodiment of the invention, the user may select a predetermined component or other option within the news feed 600, the mobile interface 602, or elsewhere, and thereby transform the news feed 600 from a vertical orientation to a horizontal orientation. In this embodiment, there may be a specific component that activates the horizontal news feed 606. In an embodiment of the invention, the user may select a component by tapping on the component within the screen of the mobile device 601 or by otherwise selecting the component in accordance with the features and capabilities of the input system of the mobile device 601. Alternatively or additionally, the user may provide any other input to the mobile device 601, such as a voice command, to cause the transformation of the news feed from one orientation to another orientation.

In response to the user's selection, the news feed may be transformed for horizontal scrolling to display news stories that correspond to those of the vertical news feed 600. News stories 603, 604, and 605 of the vertical news feed 600 correspond to news stories 607, 608, and 609, respectively, of the horizontal news feed 606. In the horizontal news feed 606, the story that is presented to the user is story 607, which pertains to the same activity as the story 603. According to an embodiment of the invention, the story that is initially presented to the user within the horizontal news feed 606 corresponds to the related story in the vertical news feed 600 containing the component with which the user interacted. In contrast to the news stories in the vertical news feed 600 in which components of news stories may be omitted, the news stories in the horizontal news feed 606 may be rendered with an expanded set of components analogous to those of the news stories 503-508 in FIG. 5. Omitted components of the news stories in the vertical news feed 600 may be included as components of the news stories in the horizontal news feed 606. According to one embodiment of the invention, the user may go from the horizontal news feed 606 back to the vertical news feed 600 by selecting an option within the mobile interface 602, within the horizontal news feed 606, or of the mobile device 601, such as a “back” button (not shown). In this way, the user may navigate a vertical news feed with compacted news stories or a horizontal news feed with expanded news stories as he wishes. As discussed, a vertical news feed may present relatively fewer components in news stories, or other references, than a horizontal news feed. However, in another embodiment, a vertical news feed may present more components in news stories, or other references, than a horizontal news feed. The relative amount of components of news stories, or other references, presented in a particular orientation for a news feed or other stream may vary.

Although the preceding examples have been described with reference to mobile devices, bi-directional viewing and scrolling in accordance with the techniques illustrated herein may be possible on any type of device. For example, bi-directional display of content may be implemented on a desktop computer where the user may select a component that “flips” a news feed using an input mechanism such as a mouse. On desktop or tablet displays that include touchscreens, the user may select a component or provide an input that “flips” a news feed by tapping on or otherwise selecting the component within the screen of the display in accordance with their features and capabilities. In addition, transformation of a news feed from one orientation to another orientation may be triggered by any other user input to the computer system, such as a voice command.

Moreover, while complementary vertical scrolling orientation and horizontal scrolling orientation have been described, news feed presentation may occur with other orientations. For example, the orientations may be orthogonal or substantially orthogonal. As another example, the orientations may be non-orthogonal. Further, in an embodiment, multi-dimensional viewing and scrolling may be provided in more than two orientations.

Similarly, although the preceding examples have been described with reference to news feeds and news stories, bi-directional viewing in accordance with the techniques illustrated herein may be possible with any other type of information. For example, a variety of references for serial presentation in the form of a stream, apart from news stories and news feeds, may be used in accordance with the embodiments described herein. These references, which may or may not relate to content of the social networking system 130, may be displayed and scrolled using a bi-directional interface in the manner similar to the examples described and illustrated herein.

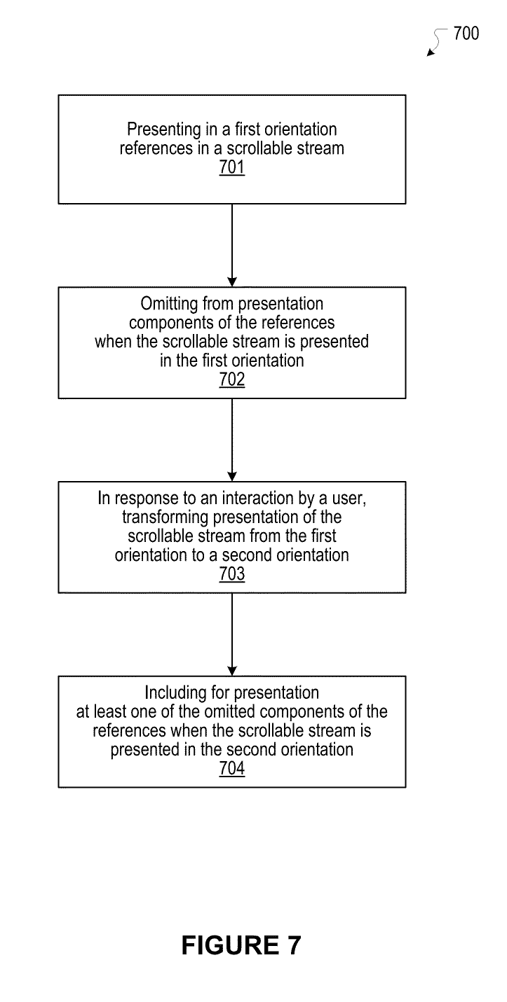

FIG. 7 depicts an example process 700 for displaying a bi-directional stream of references with a client device, such as the user device 110, in accordance with an embodiment of the invention. The client device may be any device capable of displaying information to a user. In block 701, references are, in a first orientation, presented in a scrollable stream. The stream may include discrete content items, such as a news feed or a user profile, or other references that are presented in a series. In block 702, components of the references are omitted from presentation when the scrollable stream is presented in the first orientation. The first orientation may be a vertical orientation or a horizontal orientation. The components may be omitted based on display constraints in presenting the stream in the first orientation.

In block 703, in response to an interaction by a user, presentation of the scrollable stream is transformed from the first orientation to a second orientation. The second orientation may be orthogonal to the first orientation. According to one embodiment of the invention, the interaction may be with a content item within the stream, any component within a content item of the stream, or a particular component within the content item of the stream. In block 704, one or more of the omitted components of the references are included for presentation when the scrollable stream is presented in the second orientation. According to one embodiment of the invention, a content item that may be displayed to the user in the stream having the second orientation pertains to the same activity as the content item with which the user interacted in the stream having the first orientation. According to another embodiment, each content item in the stream having the second orientation comprises a greater number of components than its analogous content item in the stream having the first orientation. The “hidden” components in content items of a stream in the first orientation may be “un-hidden” in a stream in the second orientation. The process 700 may be entirely or partially performed by the news feed rendering module 118.

### Hardware Implementation

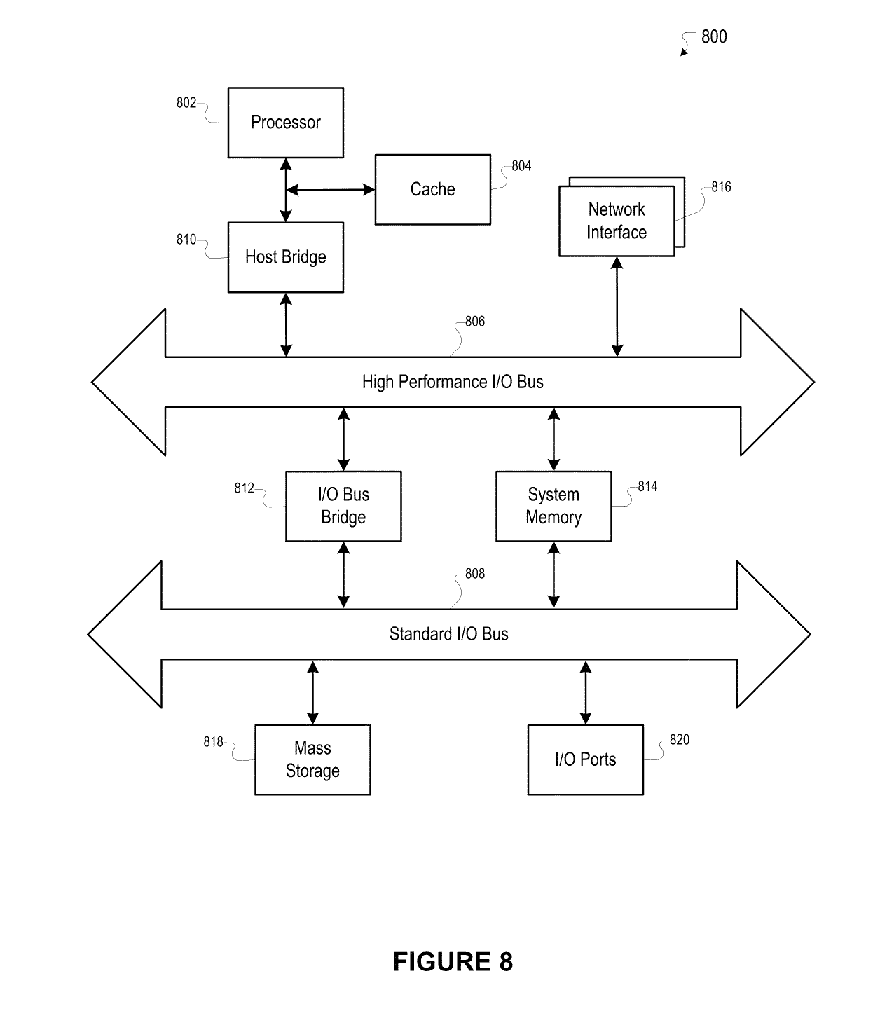

The foregoing processes and features can be implemented by a wide variety of machine and computer system architectures and in a wide variety of network and computing environments. FIG. 8 illustrates an example of a computer system 800 that may be used to implement one or more of the computing devices identified above. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 130, the user device 110, and the external system 120, or a component thereof. In an embodiment of the invention, the computer system 800 may be one server among many that constitutes all or part of the social networking system 130.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System; the Apple Macintosh Operating System, available from Apple Computer Inc. of Cupertino, Calif.; UNIX operating systems; Microsoft® Windows® operating systems; BSD operating systems; and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Furthermore, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer-readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
presenting, by at least one computing device, in a first orientation references in a scrollable stream; and
in response to an interaction by a user, transforming, by the at least one computing device, presentation of the scrollable stream from the first orientation to a second orientation.

2. The method of claim 1, wherein the first orientation is vertical.

3. The method of claim 1, wherein the first orientation and the second orientation are different.

4. The method of claim 1, wherein the first orientation and the second orientation are orthogonal.

5. The method of claim 1, wherein the scrollable stream is a news feed.

6. The method of claim 1, wherein the references include news stories.

7. The method of claim 1, wherein the scrollable stream is presented in a webpage of a social networking system.

8. The method of claim 1, wherein the scrollable stream is associated with activities in a social networking system, the activities including at least one of an article posting, a link posting, a new friendship, a status update, and a photo upload.

9. The method of claim 1, wherein the interaction includes selection of a reference in the scrollable stream.

10. The method of claim 1, wherein the interaction includes selection of a predetermined component of a reference.

11. The method of claim 1, wherein the interaction includes selection of any component of a reference.

12. The method of claim 1, wherein the computing device is at least one of a mobile device, a tablet device, and a desktop computer.

13. The method of claim 1, wherein the interaction includes user action applied to an input system of the computing device.

14. The method of claim 1, further comprising omitting from presentation components of the references when the scrollable stream is presented in the first orientation.

15. The method of claim 14, further comprising including for presentation at least one of the omitted components of the references when the scrollable stream is presented in the second orientation.

16. The method of claim 1, further comprising scrolling the scrollable stream in the first orientation and the second orientation.

17. The method of claim 17, further comprising scrolling a reference in the first orientation.

18. The method of claim 1, further comprising allowing toggling between scrolling in the first orientation and the second orientation based on a user action.

19. A system comprising:
at least one processor; and
a memory storing instructions configured to instruct the at least one processor to perform:
presenting in a first orientation references in a scrollable stream; and
in response to an interaction by a user, transforming presentation of the scrollable stream from the first orientation to a second orientation.

20. A computer storage medium storing computer-executable instructions that, when executed, cause a computer system to perform a computer-implemented method comprising:
presenting in a first orientation references in a scrollable stream; and
in response to an interaction by a user, transforming presentation of the scrollable stream from the first orientation to a second orientation.
